(19) United States
(12) Patent Application Publication
(10) Pub. No.: US 2025/0078207 A1
(43) Pub. Date: Mar. 6, 2025

(54) VIDEO FRAME REPAIR METHOD, APPARATUS, DEVICE, STORAGE MEDIUM AND PROGRAM PRODUCT

(71) Applicant: Beijing Zitiao Network Technology Co., Ltd., Beijing (CN)

(72) Inventor: Hang DONG, Beijing (CN)

(21) Appl. No.: 18/725,733

(22) PCT Filed: Dec. 27, 2022
(86) PCT No.: PCT/CN2022/142391

§ 371 Date: Jun. 28, 2024

(30) Foreign Application Priority Data
Dec. 30, 2021 (CN) 202111649318.9

(51) Int. Cl. G06T 5/50; G06T 5/60

(52) U.S. Cl. CPC G06T 5/50; G06T 5/60; G06T 2207/10016; G06T 2207/20084; G06T 2207/20221

(57) ABSTRACT

The embodiments of the present disclosure relate to a video frame repair method, apparatus, device, storage medium, and program product. The method comprises: acquiring a video frame group from a video, wherein the video frame group comprises the target video frame and video frames adjacent to the target video frame; inputting the video frame group into an attention transformation network to obtain a video frame group to be fused, wherein the attention transformation network comprises a set of attention transformation modules that are connected in series, an input of the attention transformation network is an input of a first attention transformation module in the set, and the video frame group comprises a video frame that is output by one or more-attention transformation modules and corresponds to the target video frame; and processing the video frame group to be fused to obtain a repaired target video frame.

### CROSS-REFERENCE TO RELATED APPLICATIONS

The present application is a National Stage Entry of International application No. PCT/CN2022/142391 filed on Dec. 27, 2022, which is based on and claims priority of China Patent Application number 202111649318.9, filed on Dec. 30, 2021, the disclosure of which is hereby incorporated herein in its entirety.

### TECHNICAL FIELD

The present disclosure relates to the field of video processing technology, and in particular, to a video frame repair method, apparatus, device, storage medium and program product.

### BACKGROUND

Video repair is a kind of classic computer vision task, whose goal is to repair and enhance low-quality input videos to obtain clearer and more detailed videos.

Compared with image repair problem, the video repair problem requires effective use of information from adjacent frames to obtain more detailed information.

### SUMMARY

Embodiments of the present disclosure provide a video frame repair method, apparatus, device, storage medium and program product, which process each of adjacent frames through a plurality of attention transformation networks that are connected in series, taking into account the attention between the adjacent frames, which improves the fusion effect.

In a first aspect, an embodiment of the present disclosure provides a video frame repair method, the method comprising:
acquiring a video frame group from a video to be fused, wherein the video frame group comprises a target video frame and video frames adjacent to the target video frame;
inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and
processing the video frame group to be fused to obtain a repaired target video frame.

In a second aspect, an embodiment of the present disclosure provides a video frame repair apparatus, the apparatus comprising:
a video frame group acquisition module configured to acquire a video frame group from a video to be fused, wherein the video frame group comprises a target video frame and video frames adjacent to the target video frame;
a video frame group to be fused determination module configured to input the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and
a video frame repair module configured to process the video frame group to be fused to obtain a repaired target video frame.

In a third aspect, an embodiment of the present disclosure provides an electronic device, the electronic device comprising:
one or more processors;
a storage for storing one or more programs;
when executed by the one or more processors, the one or more programs cause the one or more processors to implement the video frame repair method of any one of the first aspect as described above.

In a fourth aspect, an embodiment of the present disclosure provides a computer-readable storage medium having a computer program stored thereon, which, when executed by a processor, implements the video frame repair method of any one of the first aspect as described above.

In a fifth aspect, an embodiment of the present disclosure provides a computer program product including a computer program or an instruction, which, when executed by a processor, implements the video frame repair method of any one of the first aspect as described above.

The embodiments of the present disclosure provide a video frame repair method, apparatus, device, storage medium and program product. The method comprises: acquiring a video frame group from a video to be fused, wherein the video frame group comprises a target video frame and video frames adjacent to the target video frame; inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and processing the video frame group to be fused to obtain a repaired target video frame.

### BRIEF DESCRIPTION OF THE DRAWINGS

The above and other features, advantages, and aspects of embodiments of the present disclosure will become more apparent in conjunction with the accompanying drawings and with reference to the following detailed description. Throughout the drawings, the like or similar reference signs indicate the like or similar elements. It should be understood that the drawings are schematic and the originals and elements are not necessarily drawn to scale.

FIG. 1 is a schematic structural diagram of an attention transformation module in an embodiment of the present disclosure;

FIG. 2 is a schematic structural diagram of a multi-head attention principle in an embodiment of the present disclosure;

FIG. 3 is a flow chart of a video frame repair method in an embodiment of the present disclosure;

FIG. 4 is a flow chart of video frame repair in an embodiment of the present disclosure;

FIG. 5 is a schematic diagram of a feature block division in an embodiment of the present disclosure;

FIG. 6 is a structural block diagram of an attention calculation process in an embodiment of the present disclosure;

FIG. 7 is a schematic structural diagram of a video frame repair apparatus in an embodiment of the present disclosure; and

FIG. 8 is a schematic structural diagram of an electronic device in an embodiment of the present disclosure.

### DETAILED DESCRIPTION

Hereinafter, embodiments of the present disclosure will be described in more detail with reference to the accompanying drawings. Although some embodiments of the present disclosure are shown in the drawings, it should be understood that the present disclosure can be implemented in many different forms, which should not be construed as being limited to embodiments set forth herein, rather, these embodiments are provided for a more thorough and complete understanding of the present disclosure. It should be understood that the drawings and embodiments of the present disclosure should be explained as merely illustrative, and not as a limitation to the protection scope of the present disclosure.

It should be understood that various steps recited in the method embodiments of the present disclosure may be executed in a different order, and/or executed in parallel. In addition, the method implementations may include additional steps and/or omit to perform illustrated steps. The scope of the present disclosure is not limited in this respect.

The term “including” and its variants as used herein are open includes, that is, “including but not limited to”. The term “based on” means “based at least in part on.” The term “one embodiment” means “at least one embodiment”; the term “another embodiment” means “at least one additional embodiment”; the term “some embodiments” means “at least some embodiments.” Related definitions of other terms will be given in following description.

It should be noted that the concepts of “first” and “second” etc. mentioned in the present disclosure are only used to distinguish between different apparatus, modules or units, and are not used to limit the order of functions performed by these apparatus, modules or units or their interdependence.

It should be noted that modifiers of “one” and “a plurality of” mentioned in the present disclosure are illustrative and not restrictive, and those skilled in the art should understand that they should be construed as “one or more” unless the context clearly indicates otherwise.

The names of messages or information interacted between a plurality of apparatus in the embodiments of the present disclosure are only used for illustration, and are not used to limit the scope of these messages or information.

Video repair is a kind of classic computer vision task, whose goal is to repair and enhance low-quality input videos to obtain clearer and more detailed videos. In recent years, with the improvement of network bandwidth, video contents such as short videos, live broadcasts have become one of the most common communication media in people's daily lives.

Compared with image repair problem, the video repair problem requires effective use of information from adjacent frames to obtain more detailed information. Therefore, most video repair networks can be divided into a motion compensation module, a multi-frame feature fusion module, and an image reconstruction module.

Wherein, the multi-frame feature fusion module is mainly responsible for effectively fusing multi-frame features that have passed through the motion compensation module. The motion compensation module can eliminate displacements between adjacent frames due to camera and background motion, so that the subsequent multi-frame fusion module can effectively perform information fusion. The operation process of the motion compensation module can usually be expressed as:

$${F}_{t , fusion} = F ( {F}_{t - i} , … , {F}_{t - 1} , {F}_{t} , {F}_{t + 1} , … , {F}_{t + i} )$$

Wherein, F_{t,fusion} represents a feature that has been motion compensated, and Fₜ subscript represents a timestamp of the feature.

The multi-frame fusion is very important for the final repaired image reconstruction. Different adjacent frames provide different amounts of information for the reference frame due to temporal position, blur degree, and parallax issues; frames with poor alignment effect are detrimental to subsequent image reconstruction. Therefore, when fusing multi-frame features, it is necessary to effectively select and fuse features on adjacent frames.

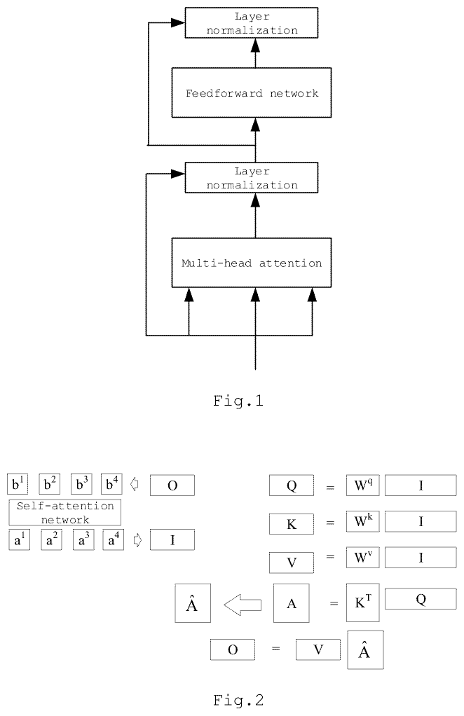

The attention Transformer network was first used in speech tasks. It processes a speech sequence by obtaining global attention, including self-attention, for the speech sequence. It can effectively replace the Recurrent Neural Network (RNN) to avoid the information forgetting problem of the RNN network when processing long sequences. As shown in FIG. 1, one Transformer module consists of Multi-head Attention, Feedforward Network (FFN) and Layer Normalization (Norm).

Wherein, the Multi-head Attention is the core of the Transformer module, as shown in FIG. 2. Its working principle is: (a¹, a², a³, a⁴) being input to a sub-attention network as an input matrix I, and the input matrix I being multiplied by three different matrices W^{q}, W^{k}, and W^{v} respectively to obtain three intermediate matrices Q, K, and V. Wherein, the dimensions of matrix Q, matrix K, and matrix V are the same. After transposing the matrix K and multiplying it by the matrix Q, the attention matrix A is obtained, wherein, A∈R (N, N) represents the attention between the two at each position. Then invert the attention matrix A to obtain a matrix Â, and finally multiply Â by the matrix V to obtain an output matrix O, which is (b¹, b², b³, b⁴).

The current multi-frame feature fusion module mainly adopts a fusion method based on spatial and channel attention, wherein the spatial attention considers only the relationship between two adjacent frames, and attempts to fuse multiple frames through only a single fusion. This method tends to fail to take into account the relationship between multiple adjacent frames, and the single fusion strategy also leads to unstable fusion.

In order to solve the above problems, an embodiment of the present disclosure provides a video frame repair method, which processes each of adjacent frames through a plurality of attention transformation networks that are connected in series, taking into account the attention between adjacent frames, and improving the fusion effect.

The video frame repair method proposed in the embodiment of the present application will be introduced in detail below with reference to the accompanying drawings.

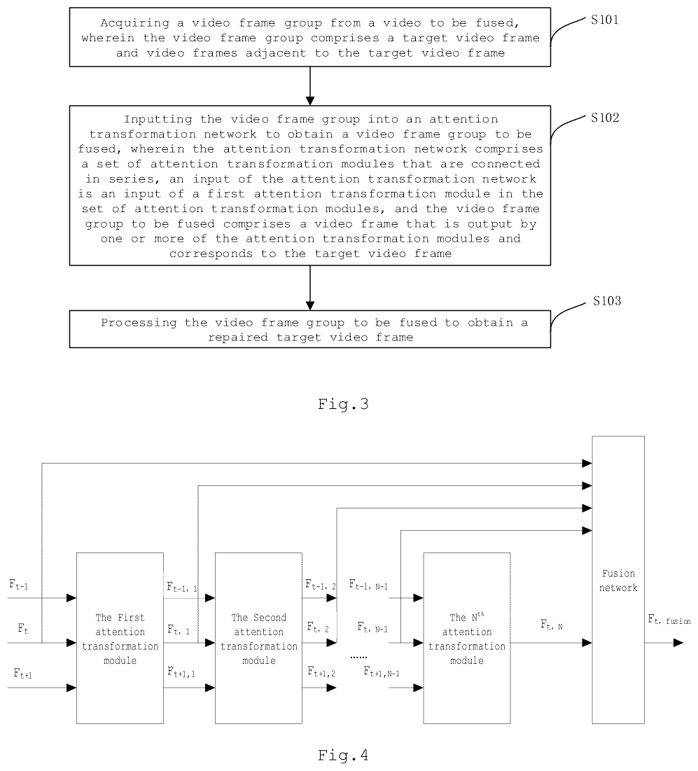

FIG. 3 is a flow chart of a video frame repair method in an embodiment of the present disclosure. This embodiment can be applied to situations of repairing videos. The method may be executed by a video frame repair apparatus, which may be implemented by using software and/or hardware, and may be configured in an electronic device.

For example: the electronic device may be a mobile terminal, a fixed terminal or a portable terminal, such as a mobile phone, a site, a unit, a device, a multimedia computer, a multimedia tablet, an Internet node, a communicator, a desktop computer, a laptop computer, a notebook computer, a netbook computer, a tablet computer, a Personal Communications System (PCS) device, a personal navigation device, a Personal Digital Assistant (PDA), an audio/video player, a digital camera/camcorder, a positioning device, a television receiver, a radio broadcast receiver, an e-book device, a gaming device, or any combination thereof, including accessories and peripherals for these devices or any combination thereof.

For another example: the electronic device may be a server, wherein the server may be a physical server or a cloud server, and the server may be one server or a cluster of servers.

As shown in FIG. 3, the video frame repair method provided by the embodiment of the present disclosure mainly includes the following steps:

S101. Acquiring a video frame group from a video to be fused, wherein the video frame group comprises a target video frame and video frames adjacent to the target video frame.

Wherein, the video to be fused may include video segments that need to be repaired. The video to be fused may be a video captured in real time by a camera, or may be video data input through an input apparatus.

Further, the video to be fused may include video frames that have been motion compensated by a motion compensation module, that is, the video frame group is a video frame group that have been motion compensated.

In this embodiment, the target video frame can be understood as a video frame that needs to be repaired, for example, the video frame at the current moment, and the adjacent video frames can be understood as two video frames adjacent to the target video frame. It should be noted that, in this embodiment, the target video frame is represented by Fₜ, the preceding video frame of the two adjacent video frames is represented by Fₜ₋₁, and the subsequent video frame of the two adjacent video frames is represented by Fₜ₊₁.

Acquiring the video frame group from the video to be fused may be acquiring, through the motion compensation module, a video frame group that have been motion compensated.

S102. Inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame.

In this embodiment, the set of attention transformation modules that are connected in series are connected end to end. An input of the attention transformation network is an input of the first attention transformation module in the set of attention transformation modules. After global attention processing is performed on a received video frame group by the first attention transformation module, it outputs to a second attention transformation module, and then, after performing attention processing, it outputs to the subsequent attention transformation module, that is, an output of the previous attention transformation module is an input of the subsequent attention transformation module, until the last attention transformation network outputs video frames to be fused.

In one possible implementation, in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

As shown in FIG. 4, a set of N attention transformation modules are connected end to end. The first attention transformation module receives the target video frame Fₜ and adjacent video frames Fₜ₋₁ and Fₜ₊₁. The first attention transformation module processes the target video frame Fₜ and the adjacent video frame Fₜ₋₁ and Fₜ₊₁, and then outputs the target video frame F_{t, 1} that has been performed global attention processing once and the adjacent video frames F_{t-1, 1 and F}_{t+1, 1} that have been performed global attention processing once, inputting the target video frame F_{t, 1} that has been performed global attention processing once and the adjacent video frames F_{t-1, 1} and F_{t+1, 1} that have been performed global attention processing once to the second attention transformation module, and the second attention transformation module performs global attention processing on the target video frame F_{t, 1} that has been performed global attention processing once and the adjacent video frames F_{t-1, 1} and F_{t+1, 1} that have been performed global attention processing once, and then outputs the target video frame F_{t, 2} that has been performed global attention processing twice and the adjacent video frames F_{t-1, 2} and F_{t+1, 2} that have been performed global attention processing twice to the third attention transformation module, and so on, the video frame group output by the previous attention transformation module is continuously used as the input video frame group of the subsequent attention transformation network; until the Nth attention transformation module receives the target video frame F_{t, N-1} that has been performed global attention processing N−1 times and the adjacent video frames F_{t-1, N-1} and F_{t+1, N-1} that have been performed global attention processing N−1 times, and the Nth attention transformation module performs global attention processing on the target video frame F_{t, N-1} that has been performed global attention processing N−1 times and the adjacent video frames F_{t-1, N-1} and F_{t+1, N-1} that have been performed global attention processing N−1 times, and then outputs the video frame F_{t, N} to be fused.

In one possible implementation, the process of processing the input video frame group by the attention transformation module comprises: dividing the target video frame and the adjacent video frames in the video frame group into a plurality of images blocks respectively; for each image block in the target video frame, performing global attention calculation with corresponding image block in the adjacent video frames; and splicing a plurality of image blocks that have been performed global attention calculation to obtain a processed video frame corresponding to the target video frame.

Wherein, dividing into a plurality of image blocks may be dividing averagely according to area, for example, dividing averagely according to a four-cell grid, or dividing averagely into four parts in parallel horizontally, etc. dividing may also be done according to image types in video frames. For example: a background image is a part, a character image is a part, a building is a part, etc.; for another example: when an image is mainly about a person, a background image is a part, an avatar of the person is a part, and a torso of the person is a part. It should be noted that, this embodiment only exemplifies division methods for feature blocks, which are not limited.

In this embodiment, take the first attention transformation module processing the target video frame Fₜ as an example for explanation. As shown in FIG. 5, the target video frame Fₜ may be divided into 4 image blocks, and each image block is performed global attention calculation with respect to corresponding image block in the adjacent video frame.

In this embodiment, global attention is performed for each image block. Although this method abandons the self-attention mechanism of the entire image for the sake of efficiency, it is not very serious issue for the multi-frame fusion module for video repair problems. Since input features of the multi-frame fusion module are motion compensated features, useful adjacent frame features have been aligned into the same image block, so there is no need to acquire global attention.

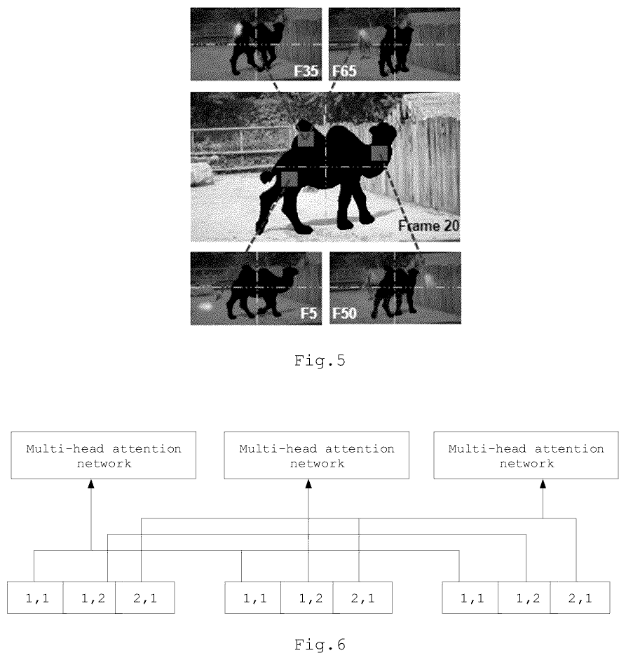

As shown in FIG. 6, take the multi-head attention network being 3 layers as an example to explain the global attention calculation. Acquired input matrices are (1, 1), (1, 2) and (2, 1) and a 3-layer multi-head attention network is inputted for global attention calculation, and the global attention calculation results of the 3-layer multi-head attention network are merged to obtain the global attention calculation of this feature block.

It should be noted that the method for multi-head attention network to calculate global attention every time is specifically shown in FIG. 2. Reference can be made to the description in the above embodiment, which will not be repeated again in this embodiment.

S103. Processing the video frame group to be fused to obtain a repaired target video frame.

Further, as shown in FIG. 4, acquiring the target video frame F_{t, 1} output by the first attention transformation module and that has been performed global attention processing once, acquiring the target video frame F_{t, 2} output by the second attention transformation module and that has been performed global attention processing twice, . . . , acquiring the target video frame F_{t, N-1} output by the N−1-th attention transformation module and that has been performed global attention processing N−1 times; inputting the target video frame F_{t, 1} that has been performed global attention processing force, the target video frame F_{t, 2} that has been performed second global attention processing twice, . . . , the target video frame F_{t, N-1} that has been performed global attention processing N−1 times and the video frame to be fused F_{t, N} output by the N-th attention transformation network to the fusion network, to obtain the fused video frame F_{t, fusion}.

In this way, features from multiple fusion processes can be reused effectively, so as to avoid fusion instability issue caused by a single fusion.

In an embodiment of the present disclosure, an obtained fused intermediate frame F_{t, fusion} is then sent to a subsequent image reconstruction network to obtain a repaired intermediate frame image.

An embodiment of the present disclosure provides a video frame repair method comprising: acquiring a video frame group from a video to be fused, wherein the video frame group comprises a target video frame and video frames adjacent to the target video frame; inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and processing the video frame group to be fused to obtain a repaired target video frame. An embodiment of the present disclosure processes each of adjacent frames through a plurality of attention transformation networks that are connected in series, taking into account the attention between the adjacent frames, which improves the fusion effect.

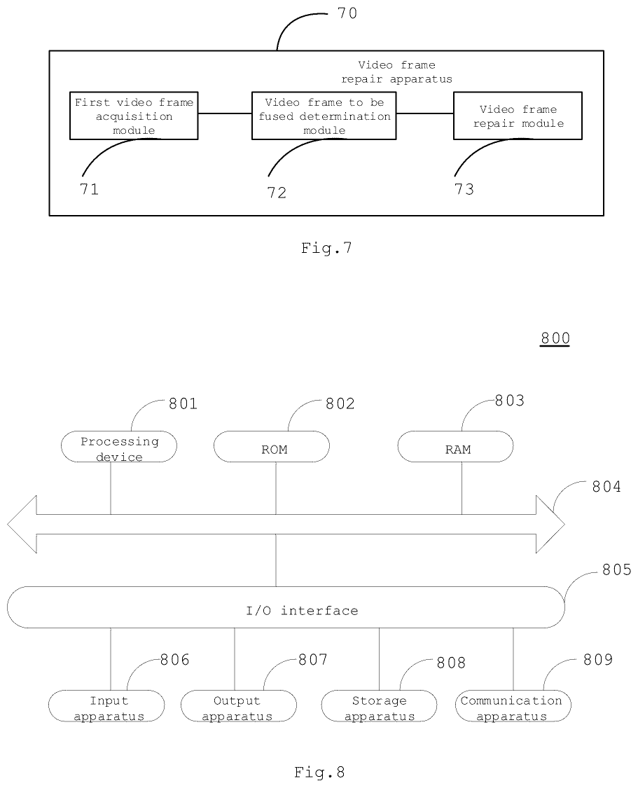

FIG. 7 is a schematic structural diagram of a video frame repair apparatus in an embodiment of the present disclosure. This embodiment can be applied to situation of repairing videos. The method may be executed by a video frame repair apparatus, which may be implemented by using software and/or hardware, and may be configured in an electronic device.

As shown in FIG. 7, the video frame repair apparatus 70 provided by an embodiment of the present disclosure mainly comprises: a video frame group acquisition module 71, a video frame to be fused determination module 72 and a video frame repair module 73.

Wherein, the video frame group acquisition module 71 is configured to acquire a video frame group from a video to be fused, wherein the video frame group comprises a target video frame and video frames adjacent to the target video frame;

The video frame group to be fused determination module 72 is configured to input the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and

The video frame repair module 73 is configured to process the video frame group to be fused to obtain a repaired target video frame.

An embodiment of the present disclosure provides a video frame repair apparatus for performing the following process: acquiring a video frame group from a video to be fused, wherein the video frame group comprises a target video frame and video frames adjacent to the target video frame; inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and processing the video frame group to be fused to obtain a repaired target video frame. An embodiment of the present disclosure processes each of adjacent frames through a plurality of attention transformation networks that are connected in series, taking into account the attention between the adjacent frames, which improves the fusion effect.

In one possible implementation, in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

In one possible implementation, the video frame group to be fused determination module 72 comprises:
an image block dividing unit configured to divide the target video frame and the adjacent video frames in the video frame group into a plurality of image blocks respectively;
an attention calculation unit configured to, for each image block in the target video frame, perform global attention calculation with corresponding image block in the adjacent video frames; and
an image block splicing unit configured to splice a plurality of image blocks that have been performed global attention calculation to obtain a processed video frame corresponding to the target video frame.

Specifically, the target video frame and the adjacent video frames in the video frame group are all motion compensated video frames.

In one possible implementation, the video frame repair module 73 comprises:
a video frame fusion unit configured to input the video frame group to be fused to a fusion network to obtain a fused video frame corresponding to the target video frame; and
a video frame repair unit configured to input the fused video frame to an image reconstruction network to obtain a repaired target video frame.

The video frame repair apparatus provided by the embodiment of the present disclosure can perform the steps performed in the video frame repair method provided by the method embodiment of the present disclosure. The execution steps and beneficial effects will not be repeated here again.

FIG. 8 is a schematic structural diagram of an electronic device in an embodiment of the present disclosure. Referring specifically to FIG. 8 below, it shows a schematic structural diagram suitable for implementing an electronic device 800 in an embodiment of the present disclosure. The electronic device 800 in the embodiment of the present disclosure may include, but is not limited to a mobile terminal such as a mobile phone, a notebook, a digital broadcast receiver, a PDA (Personal Digital Assistant), a PAD (tablet), a PMP (Portable Multimedia Player), a vehicle-mounted terminal (for example, a vehicle-mounted navigation terminal), a wearable terminal device, etc. and a fixed terminal such as a digital TV, a desktop computer, a smart home appliance, etc. The electronic device shown in FIG. 8 is only one example, and should not bring any limitation to functions and usage scopes of embodiments of the present disclosure.

As shown in FIG. 8, the electronic device 800 may include a processing device (e.g., a central processing unit, a graphics processor, etc.) 801, which can execute various appropriate actions and processes according to a program stored in a read-only memory (ROM) 802 or a program loaded from a storage 808 into a random-access memory (RAM) 803, to implement the method for image rendering according to the embodiments of the present disclosure. In the RAM 803, various programs and data required for the operation of the terminal device 800 are also stored. The processing apparatus 801, ROM 802 and RAM 803 are connected to each other via a bus 804. An input/output (I/O) interface 805 is also connected to bus 804.

Generally, the following apparatus may be connected to the I/O interface 805: an input apparatus 806 including, for example, a touch screen, a touch pad, a keyboard, a mouse, a camera, a microphone, an accelerometer, a gyroscope, etc.; an output apparatus 807 including, for example, a liquid crystal display (LCD), a speaker, a vibrator etc.; a storage apparatus 808 including, for example, a magnetic tape, a hard disk, etc.; and a communication apparatus 809. The communication apparatus 809 may allow the terminal device 800 to perform wireless or wired communication with other devices to exchange data. Although FIG. 8 shows the terminal device 800 having various apparatus, it should be understood that it is not required to implement or provide all of the illustrated apparatus. More or fewer apparatus may be implemented or provided alternatively.

In particular, according to the embodiments of the present disclosure, the processes described above with reference to the flowcharts may be implemented as computer software programs. For example, an embodiment of the present disclosure includes a computer program product, which includes a computer program carried on a non-transitory computer-readable medium, and the computer program contains program code for executing the method shown in the flowchart, thereby implementing the above page jumping method. In such embodiments, the computer program may be downloaded and installed from the network via the communication apparatus 809, or installed from storage apparatus 808, or installed from the ROM 702. When the computer program is executed by the processing apparatus 801, above functions defined in the methods of the embodiment of the present disclosure are executed.

It should be noted that above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier wave, in which a computer-readable program code is carried. This propagated data signal can take many forms, including but not limited to electromagnetic signals, optical signals, or any suitable combination thereof. The computer-readable signal medium may also be any computer-readable medium other than the computer-readable storage medium. The computer-readable signal medium may send, propagate, or transmit the program for use by or in combination with the instruction execution system, apparatus, or device. The program code contained on the computer-readable medium can be transmitted by any suitable medium, including but not limited to: wire, optical cable, RF (Radio Frequency), etc., or any suitable combination thereof.

In some embodiments, the client and server can communicate with any currently known or future developed network protocol such as HTTP (HyperText Transfer Protocol), and can interconnect with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future developed networks.

The above computer-readable medium may be included in above electronic devices; or it may exist alone without being assembled into the electronic devices.

The computer-readable medium carries one or more programs, which, when executed by the terminal device, cause the terminal device to: acquire a video frame group from a video to be fused, wherein the video frame group comprises a target video frame and video frames adjacent to the target video frame; input the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and process the video frame group to be fused to obtain a repaired target video frame.

In some embodiments, when one or more of the above programs are executed by the terminal device, the terminal device may also perform other steps described in the above embodiments.

The computer program code for performing the operations of the present disclosure can be written in one or more programming languages or a combination thereof. The above programming languages include but are not limited to object-oriented programming languages such as Java, Smalltalk, C++, and include conventional procedural programming languages such as “C” language or similar programming languages. The program code can be executed entirely on a user's computer, partly executed on a user's computer, executed as an independent software package, partly executed on a user's computer and partly executed on a remote computer, or entirely executed on a remote computer or server. In the case of involving a remote computer, the remote computer can be connected to a user's computer through any kind of network, including a local area network (LAN) or a wide area network (WAN), or it can be connected to an external computer (for example, connected by using Internet provided by an Internet service provider).

The flowcharts and block diagrams in the accompanying drawings illustrate possible architecture, function, and operation implementations of a system, method, and computer program product according to various embodiments of the present disclosure. In this regard, each block in a flowchart or block diagram may represent a module, program segment, or part of code, which contains one or more executable instructions for realizing specified logic functions. It should also be noted that, in some alternative implementations, functions marked in a block may also occur in a different order than the order marked in the drawings. For example, two blocks shown in succession can actually be executed substantially in parallel, and they can sometimes be executed in the reverse order, depending on functions involved. It should also be noted that each block in a block diagram and/or flowchart, and the combination of blocks in a block diagram and/or flowchart, can be implemented by a dedicated hardware-based system that performs the specified functions or operations, or it can be implemented by a combination of dedicated hardware and computer instructions.

The units involved in the embodiments of the present disclosure can be implemented in software or hardware. Wherein, the name of the unit does not constitute a limitation on the unit itself under certain circumstances.

The functions described herein above may be performed at least in part by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logical device (CPLD) and so on.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of machine-readable storage media may include an electrical connection based on one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides a video frame repair method, comprising: acquiring a video frame group from a video to be fused, wherein the video frame group comprises a target video frame and video frames adjacent to the target video frame; inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and processing the video frame group to be fused to obtain a repaired target video frame. According to one or more embodiments of the present disclosure, the present disclosure provides a video frame repair method, wherein, in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

According to one or more embodiments of the present disclosure, the present disclosure provides a video frame repair method, wherein, the process of processing the input video frame group by the attention transformation module comprises: dividing the target video frame and the adjacent video frames in the video frame group into a plurality of images blocks respectively; for each image block in the target video frame, performing global attention calculation with corresponding image block in the adjacent video frames; and splicing a plurality of image blocks that have been performed global attention calculation to obtain a processed video frame corresponding to the target video frame.

According to one or more embodiments of the present disclosure, the present disclosure provides a video frame repair method, wherein, the target video frame and the adjacent video frames in the video frame group are all motion compensated video frames.

According to one or more embodiments of the present disclosure, the present disclosure provides a video frame repair method, wherein, processing the video frame group to be fused to obtain a repaired target video frame comprises: inputting the video frame group to be fused to a fusion network to obtain a fused video frame corresponding to the target video frame; and inputting the fused video frame to an image reconstruction network to obtain a repaired target video frame.

According to one or more embodiments of the present disclosure, the present disclosure provides a video frame repair apparatus, the apparatus comprising: a video frame group acquisition module configured to acquire a video frame group from a video to be fused, wherein the video frame group comprises a target video frame and video frames adjacent to the target video frame; a video frame group to be fused determination module configured to input the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises a video frame that is output by one or more of the attention transformation modules and corresponds to the target video frame; and a video frame repair module configured to process the video frame group to be fused to obtain a repaired target video frame.

According to one or more embodiments of the present disclosure, the present disclosure provides a video frame repair apparatus, wherein, in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

According to one or more embodiments of the present disclosure, the present disclosure provides a video frame repair apparatus, wherein, the video frame group to be fused determination module 72 comprises: an image block dividing unit configured to divide the target video frame and the adjacent video frames in the video frame group into a plurality of image blocks respectively; an attention calculation unit configured to, for each image block in the target video frame, perform global attention calculation with corresponding image block in the adjacent video frames; and an image block splicing unit configured to splice a plurality of image blocks that have been performed global attention calculation to obtain a processed video frame corresponding to the target video frame.

According to one or more embodiments of the present disclosure, the present disclosure provides a video frame repair apparatus, wherein, the target video frame and the adjacent video frames in the video frame group are all motion compensated video frames.

According to one or more embodiments of the present disclosure, the present disclosure provides a video frame repair apparatus, wherein, the video frame repair module 73 comprises: a video frame fusion unit configured to input the video frame group to be fused to a fusion network to obtain a fused video frame corresponding to the target video frame; and a video frame repair unit configured to input the fused video frame to an image reconstruction network to obtain a repaired target video frame.

According to one or more embodiments of the present disclosure, the present disclosure provides an electronic device, comprising:
one or more processors;
a memory configured to store one or more programs;
when executed by the one or more processors, the one or more programs cause the one or more processors to implement any of the video frame repair methods provided by present disclosure.

According to one or more embodiments of the present disclosure, the present disclosure provides a computer-readable storage medium having a computer program stored thereon, which, when executed by a processor, implements any of the video frame repair methods provided by the present disclosure.

An embodiment of the present disclosure also provides a computer program product including a computer program or an instruction, which, when executed by a processor, implements the video frame repair methods as described above.

The above description is only preferred embodiments of the present disclosure and an explanation to the technical principles applied. Those skilled in the art should understand that the scope of disclosure involved in this disclosure is not limited to technical solutions formed by specific combination of above technical features, and should also cover other technical solutions formed by arbitrarily combining above technical features or equivalent features thereof without departing from above disclosed concept. For example, those technical solutions formed by exchanging of above features and technical features disclosed in the present disclosure (but not limited to) having similar functions with each other.

In addition, although various operations are depicted in a specific order, this should not be understood as requiring these operations to be performed in the specific order shown or performed in a sequential order. Under certain circumstances, multitasking and parallel processing may be advantageous. Likewise, although several specific implementation details are included in above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Rather, the specific features and actions described above are merely exemplary forms of implementing the claims.

1. A video frame repair method, the method comprising:
acquiring a video frame group from a video to be fused, wherein the video frame group comprises a target video frame and video frames adjacent to the target video frame;
inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises video frame that is output by one or more of the attention transformation modules and corresponds to the target video frame; and
processing the video frame group to be fused to obtain a repaired target video frame.

2. The method according to claim 1, in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

3. The method according to claim 1, the process of processing the input video frame group by the attention transformation module comprises:
dividing the target video frame and the adjacent video frames in the video frame group into a plurality of images blocks respectively;
for an image block in the target video frame, performing global attention calculation with corresponding image block in the adjacent video frames; and
splicing a plurality of image blocks that have been performed global attention calculation to obtain a processed video frame corresponding to the target video frame.

4. The method according to claim 1, wherein the target video frame and the adjacent video frames in the video frame group are all motion compensated video frames.

5. The method according to claim 1, processing the video frame group to be fused to obtain a repaired target video frame comprises:
inputting the video frame group to be fused to a fusion network to obtain a fused video frame corresponding to the target video frame; and
inputting the fused video frame to an image reconstruction network to obtain a repaired target video frame.

6. (canceled)

7. (canceled)

8. An electronic device, the electronic device comprising:
one or more processors;
a storage configured to store one or more programs;
when executed by the one or more processors, the one or more programs cause the one or more processors to implement a video frame repair method, the video frame repair method comprises:
acquiring a video frame group from a video to be fused, wherein the video frame group comprises a target video frame and video frames adjacent to the target video frame;
inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises video frame that is output by one or more of the attention transformation modules and corresponds to the target video frame; and
processing the video frame group to be fused to obtain a repaired target video frame.

9. A non-transitory computer-readable storage medium having a computer program stored thereon, which, when executed by a processor, implements a video frame repair method, the video frame repair method comprises:
acquiring a video frame group from a video to be fused, wherein the video frame group comprises a target video frame and video frames adjacent to the target video frame;
inputting the video frame group into an attention transformation network to obtain a video frame group to be fused, wherein the attention transformation network comprises a set of attention transformation modules that are connected in series, an input of the attention transformation network is an input of a first attention transformation module in the set of attention transformation modules, and the video frame group to be fused comprises video frame that is output by one or more of the attention transformation modules and corresponds to the target video frame; and
processing the video frame group to be fused to obtain a repaired target video frame.

10. (canceled)

11. The non-transitory computer-readable storage medium of claim 9, wherein in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

12. The non-transitory computer-readable storage medium of claim 9, wherein the process of processing the input video frame group by the attention transformation module comprises:
dividing the target video frame and the adjacent video frames in the video frame group into a plurality of images blocks respectively;
for an image block in the target video frame, performing global attention calculation with corresponding image block in the adjacent video frames; and
splicing a plurality of image blocks that have been performed global attention calculation to obtain a processed video frame corresponding to the target video frame.

13. The non-transitory computer-readable storage medium of claim 9, wherein the target video frame and the adjacent video frames in the video frame group are all motion compensated video frames.

14. The non-transitory computer-readable storage medium of claim 9, wherein processing the video frame group to be fused to obtain a repaired target video frame comprises:
inputting the video frame group to be fused to a fusion network to obtain a fused video frame corresponding to the target video frame; and
inputting the fused video frame to an image reconstruction network to obtain a repaired target video frame.

15. The electronic device of claim 8, wherein in the attention transformation network, a video frame group output by a previous one of the attention transformation modules is an input of a subsequent one of the attention transformation modules; wherein, the video frame group output by the previous one of the attention transformation modules comprises: a video frame that is processed by the previous one of the attention transformation modules and corresponds to the target video frame, and a video frame that is processed by the previous one of the attention transformation modules and corresponds to the adjacent video frame.

16. The electronic device of claim 8, wherein the process of processing the input video frame group by the attention transformation module comprises:
dividing the target video frame and the adjacent video frames in the video frame group into a plurality of images blocks respectively;
for an image block in the target video frame, performing global attention calculation with corresponding image block in the adjacent video frames; and
splicing a plurality of image blocks that have been performed global attention calculation to obtain a processed video frame corresponding to the target video frame.

17. The electronic device of claim 8, wherein the target video frame and the adjacent video frames in the video frame group are all motion compensated video frames.

18. The electronic device of claim 8, wherein processing the video frame group to be fused to obtain a repaired target video frame comprises:
inputting the video frame group to be fused to a fusion network to obtain a fused video frame corresponding to the target video frame; and
inputting the fused video frame to an image reconstruction network to obtain a repaired target video frame.
